(19) United States
(12) Patent Application Publication
(10) Pub. No.: US 2025/0265648 A1
(43) Pub. Date: Aug. 21, 2025

(54) OPTIMIZATION OF DIGITAL ASSET SELECTION THROUGH ARTIFICIAL INTELLIGENCE AND RELATED METHODS

(71) Applicant: Stephen James MacKenzie, Wichita, KS (US)

(72) Inventor: Stephen James MacKenzie, Wichita, KS (US)

(21) Appl. No.: 19/055,373

(22) Filed: Feb. 17, 2025

Related U.S. Application Data
(60) Provisional application No. 63/554,969, filed on Feb. 17, 2024.

(51) Int. Cl. G06Q 40/04

(52) U.S. Cl. CPC G06Q 40/04

(57) ABSTRACT

Computer-implemented method, and system implementing the same, for optimizing digital asset transactions, may include: custodying in one or more first data storage system digital assets. The method may determine with a transaction optimizer module of an intelligent computing system an optimal combination of digital assets for a transaction based on a set of factors. The method may further receive from the intelligent computing system into the one or more first data storage system the optimal combination digital assets for the transaction. The method may further send with the one or more first data storage system the optimal combination of digital assets to one or more second data storage system.

### CROSS-REFERENCE TO RELATED APPLICATIONS

This application benefits from and claims priority to U.S. Provisional Patent Application Ser. No. 63/554,969, filed Feb. 17, 2024 and which is incorporated by reference in its entirety herein.

### TECHNICAL FIELD

The invention pertains to the use of artificial intelligence in at least one digital wallet to optimize the combination of various digital assets for transactions, including cryptocurrencies, non-fungible tokens, and tokenized real-world assets.

### BACKGROUND DESCRIPTION

In the rapidly evolving world of digital assets, a variety of cryptocurrencies, non-fungible tokens, tokenized real-world assets, and tokenized securities have emerged as new forms of value. These digital assets are increasingly being used for the purchase of goods and services, or being used in various forms of financial products or transactions. However, the use of these assets is not without its challenges.

One of the primary challenges is the limitation of using only one type of digital asset for a transaction, despite the fact that a user's digital wallet may hold multiple types of assets or a user may have multiple digital wallets for different asset types. This limitation can be inconvenient and inefficient, particularly when a user wishes to optimize their use of digital assets for tax, return, or other compliance purposes.

Additionally, the process of selecting the right combination of digital assets for a transaction can be time-consuming and complex. This process often resembles a barter system, where the payer and payee must negotiate in real time the combination of digital assets needed to settle a transaction.

Moreover, the acceptance of digital assets as payment is not universal. While some payees may be willing to accept a combination of digital assets, others may prefer or only accept certain types of assets. This further complicates the transaction process and can limit the utility of digital assets.

### SUMMARY

In summary, the current landscape of digital asset transactions presents several challenges related to the selection and use of digital assets, the negotiation of transactions, and the acceptance of digital assets as payment. These challenges hinder the efficiency and potential of digital asset transactions. Unlike a traditional manual barter system involving FIAT currency and or other traditional assets, digital assets pose unique challenges that make real-time manual barter impossible and/or inefficient. For example, digital assets are traded 24/7, 365 days per year on multiple exchanges: with each exchange having a slightly different price for the same asset. This is not the case with more traditional assets like stocks or bonds. Further, crypto currencies have unique tax implications and regulatory designations (which can vary from country to country) that are not present with FIAT currency. For example, BTC is treated as a commodity under CFTC guidelines while SOL is arguably a security according to the SEC. Finally, some digital assets may have been previously owned by companies or individuals that are on sanctions lists (e.g. OFAC), which prohibits their further transfer. This introduces complex dynamics not seen with traditional bartering systems.

Thus, a system and method are needed that can transform a traditional bartering system into the digital asset realm. The system and method must consider the unique aspects of digital assets (e.g. 24/7 real-time trading; various regulatory designations; tax implications; compliance) in addition to traditional aspects such as price of the goods/services being transacted and desired payment type.

In accordance with embodiments, a computer-implemented method is provided for optimizing digital asset transactions. Digital currencies or tokens are custodied in one or more first data storage system. Data from the one or more first data storage system, which includes the type of digital currencies or tokens stored, is sent into an intelligent computing system. The intelligent computing system determines an optimal combination of digital currencies or tokens for the transaction based on a set of factors. The optimal combination of digital currencies or tokens for the transaction is received from the intelligent computing system into the one or more first data storage system and sent to one or more second data storage system.

In accordance with other embodiments, a system is provided for optimizing digital asset transactions. The system comprises one or more first data storage system for custodying digital currencies or tokens, an intelligent computing system that uses data from the one or more first data storage system, and an optimal combination of digital currencies or tokens for the transaction based on a set of factors determined with the intelligent computing system. The one or more first data storage system is configured to send to one or more second data storage system the optimal combination of digital currencies or tokens.

In yet other embodiments, a non-transitory computer-readable medium is provided storing instructions that, when executed by a computer, cause the computer to perform a method for optimizing digital asset transactions. The method includes receiving data from one or more first data storage system, determining an optimal combination of digital currencies or tokens for the transaction based on a set of factors, and sending to the one or more first data storage system the optimal combination of digital currencies or tokens for the transaction.

The custodying can be self-custody (e.g. Metamask wallet) or institutional custody (e.g. Coinbase PRIME), or a combination. In the above embodiments, the intelligent computing system may utilize an orchestration layer coupled to the one or more first data storage system to coordinate the transfer of one or more digital currencies or tokens. The orchestration layer acts as a digital protocol bridge when the digital currencies or tokens operate on different blockchain networks or blockchain protocols.

### BRIEF DESCRIPTION OF THE FIGURES

FIG. 1 shows an example system for optimizing digital transactions, in an embodiment.

FIG. 2 is a flow diagram of an example method of optimizing digital asset transactions using an artificial intelligence engine in a digital asset wallet in accordance with certain embodiments described herein.

### DETAILED DESCRIPTION

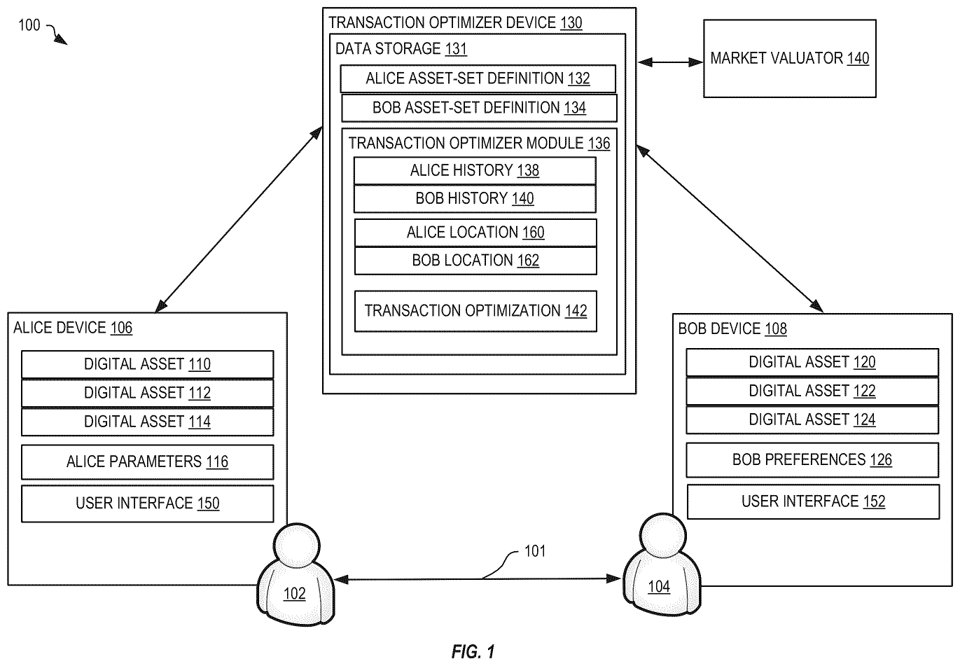

FIG. 1 shows an example system 100 for optimizing digital transactions, in an embodiment. In the embodiments herein, an example use case involves a first user 102 (also referred to as “Alice”), desiring to transact with second user 104 (also referred to as “Bob”). Connections between various components in system 100 may be implemented through known data transfer systems, such as encrypted data transfer, wired or wireless communication protocols, and various Application Programming Interface (API) call protocols known in the art.

First user 102 is shown having an associated first device 106 and second user 104 is shown having an associated second device 108. Associated first device 106 may include one or more computing devices that store information about a plurality of digital assets owned by first user 102. For example, first user 102 may have a Metamask wallet for holding ETH, a Coinbase PRIME account for holding BTC, and a Trust Wallet for holding SOL. Thus, associated first device 106 is shown including a first digital asset 110, a second digital asset 112, and a third digital asset 114. However, more or fewer digital assets may be owned by a given user without departing from scope hereof. Each digital asset may be digital currencies, tokens, or other type of digital asset. Each digital asset may be digital currencies or tokens of the same type (e.g., two bitcoin wallets owned by a given user), or may be of different types. Examples of digital currencies include Bitcoin, Ethereum, Matic, BNB, Sol, or USDC. Examples of tokens can include NFTs, tokenized securities, tokenized bonds, tokenized carbon credits, tokenized intellectual property, or other representations of real-world assets or financial instruments. Examples of physical assets include real estate title, property leases, car titles, license agreements (both tangible and intangible), tokenized treasuries, tokenized corporate bonds or securities, and physical art. Examples of intangible assets include patents, copyrights, trade marks, and trade secrets. Thus, the term “digital asset” used herein encompasses digital assets and digital representations of a physical or other tangible asset.

Associated first device 106 further includes one or more first-user parameters 116. One or more first-user parameters 116 may define user-set configuration regarding a given digital asset (e.g., one or more of digital assets 110-114). For example, in a case where one or more digital assets represents a real-world physical asset, first user 102 may desire to set a maximum or minimum value that the digital asset represents. In another example, first user 102 may force rank the digital assets 110-114 in order of fungibility 116 for a desired transaction. In yet a further example, first user 102 may include unique meta-data for a particular digital asset (e.g. autographed picture of Steph Curry associated with a basketball NFT) as part of the first-user parameters 116.

Associated second device 108 may include one or more computing devices that store information about a plurality of digital assets owned by second user 104. For example, associated second device 108 is shown including a first digital asset 120, a second digital asset 122, and a third digital asset 124. However, more or fewer digital assets may be owned by a given user without departing from scope hereof. Each digital asset may be of the same type (e.g., two bitcoin wallets owned by a given user), or may be of different types. Examples of digital currencies include Bitcoin, Ethereum, Matic, BNB, Sol, or USDC. Examples of tokens can include NFTs, tokenized securities, tokenized bonds, tokenized carbon credits, tokenized intellectual property, or other representations of real-world assets or financial instruments. Examples of physical assets include real estate title, property leases, car titles, license agreements (both tangible and intangible), tokenized treasuries, tokenized corporate bonds or securities, and physical art. Examples of intangible assets include patents, copyrights, trademarks, and trade secrets.

Each “digital asset” block in FIG. 1 not only represents data defining the given digital asset, but also a definition of the necessary information to identify and/or confirm transactions based on the given digital asset. This information may include the wallet address, public key of the user. private key of the user, geolocation, KYC or KYT (“know-your-token”) compliance history for a given digital asset, or the amount of a particular digital asset.

Associated second device 108 further includes one or more second-user parameters 126. One or more second-user parameters 126 may define user-set configuration regarding a given digital asset (e.g., one or more of digital assets 120-124). For example, in a case where one or more digital assets represents a real-world physical asset, second user 104 may desire to set a maximum or minimum value that the digital asset represents. In another example, second user 104 may indicate what digital assets are more desirable or least desirable 126 for a given transaction.

System 100 further includes a transaction optimizer device 130. Transaction optimizer device 130 may include a first data storage system 131 and associated processing system located on a mobile device, laptop, desktop, hardware wallet, USB drive, hard-drive, or cloud server. In an embodiment, the first data storage system 131 is hosted on a software application designed for use on mobile devices. The software application can be a mobile application (e.g. iOS or Android mobile app) or part of the mobile device firmware (e.g. Solana phone). In an additional or alternative embodiment, the first data storage system 131 can be hosted on-prem (e.g. laptop or desktop or server) or cloud server (e.g. AWS, Azure). An example mobile application is Metamask or Coinbase Wallet. An example cloud server is Coinbase PRIME.

As such, transaction optimizer device 130 may represent an intelligent computing system implementing artificial intelligence and/or smart contracts to implement a transaction 101 between first user 102 and second user 104. First user 102 and second user 104 may each register with transaction optimizer device 130. Once registered, data regarding each digital asset owned (or desired to be transacted with using transaction facilitation module 130) is transmitted from the respective associated first device 106 and associated second device 108 to, and received by, transaction optimizer device 130. Data received from first device 106 is stored as first-user asset-set definition 132. Data received from second device 108 is stored as second-user asset-set definition 134. In embodiments, first-user asset-set definition 132 and second-user asset-set definition 134 may include the actual digital assets owned by each of first user 102 and second user 104, or may include just a description of the assets (e.g., necessary identifiers, and current valuations thereof). Therefore, transaction optimizer device 130 may serve as a custodian of the digital assets, or may serve simply as an agent defining available assets for one or more transactions between first user 102 and second user 104.

Although shown as a single block in FIG. 1, transaction optimizer device 130 may be distributed across a plurality of data storage devices (such as a distributed cloud-computing system) where one or more first data storage system 131 custodies a single type of digital asset each (e.g. BTC in one first data storage system, ETH in another first data storage system). In this case, each first data storage system 131 acts as a separate custodian.

Transaction optimizer device 130 includes a transaction optimizer module 136. Additionally or alternatively, transaction optimizer module 136 may reside on one or both of associated first device 106 and associated second device 108 to allow respective user device to respond to a transaction request from the other user device with an optimal blend of digital assets owned by the user.

Transaction optimizer module 136 determines an optimal combination of each user's digital assets (e.g., digital currencies or tokens) for a transaction based on a set of factors or selection criteria. One example factor includes the type and value of digital currencies or tokens as defined by first-user asset-set definition 132 and second-user asset-set definition 134 in the data storage system 131. Another example factor includes the value of goods or services involved in the transaction which are either based on real-world current market value as received by transaction optimizer device 130 from a third-party market valuator (which may be readily available through a third party such as a Kelly Blue Book for vehicles, real-time digital currency or token exchange data, or not readily available such as an IP monetary evaluation requested such as by a third-party IP evaluator) or based on user-set valuations such as defined in one or more first-user parameters 116 and/or one or more second-user parameters 126. Another example factor includes first user 102 and second user 104 past purchasing history, investment risk profile, or other historical data (shown stored as first user history 138 and second user history 140.

To initiate a transaction, one or both of first user 102 and second user 104 may interact with a user interface on associated first device 106 and associated second device 108, respectively, and transmit a definition of an asset to be sold within the transaction. This may be an active request to initiate the transaction, or there may be automatic transaction settings defined by first user 102 and/or second user 104 (and defined within one or more first-user parameters 116 and one or more second-user parameters 126, respectively) to allow for automatic transactions to be processed by transaction optimizer device 130.

Transaction optimizer device 130 receives parameters of a first side of the transaction, and then processes the information associated with first-user asset-set definition 132 and second-user asset-set definition 134 to determine the optimal combination of digital assets between first user 102 and second user 104 to complete for the transaction (referred to herein as transaction optimization 142). For example, to initiate transaction optimization 142, first user 101 (acting as a payee in a given transaction in this example) may interact with user interface 150. Said interaction is relayed to transaction optimizer module 136 which in turn defines at least one selection criteria for the transaction optimizer module 136 to consider when generating transaction optimization 142. The selection criteria can include, for example: the type of cryptocurrency, gain to one or more parties from the transfer of a digital asset, loss to one or more parties from the transfer of a digital asset, and request of a certain digital asset from another party. Other selection criteria are possible including: least favorite digital asset stored in the first data storage system, most favorite digital asset stored in the first data storage system, interest bearing digital assets stored in the first data storage system, and type of digital asset stored in the first data storage system (e.g. patent, real estate title, loan). Advantageously, in at least one embodiment, transaction optimizer device 130 does not actually process the transaction, thereby eliminating various security and financial compliance requirements to implement transaction optimizer device 130. Instead, transaction optimization 142 may be transmitted to one or both of associated first device 106 and associated second device 108 for acceptance, refusal, or counter thereof. Once accepted, each associated first device 106 may implement the parameters defined by transaction optimization 142, and send confirmation to either the other of associated first device 106 or associated second device 108, or to transaction optimizer device 130 for close of escrow of the transaction optimization 142. In addition, in at least one embodiment, transaction optimizer device 130 considers the regulatory designation of each digital asset and tax implications of the contemplated transaction, and will flag a potential combination as being out-of-compliance.

Alternatively, in embodiments where the actual digital assets are transferred from associated first device 106 and associated second device 108 to transaction optimizer device 130, the transaction optimizer device 130 may transmit the transaction optimization 142 to each associated first device 106 and associated second device 108, and then receive official approval from each respective first user 102 and second user 104, and then complete the transaction and transfer the transacted digital assets to each associated first device 106 and associated second device 108, respectively.

In this alternate embodiment, the digital assets remain on the one or more first data storage system 131 of transaction optimizer device 130 until transferred to one or more second data storage systems (e.g., associated first device 106 and associated second device 108 or an agent(s) thereof). The one or more first data storage system 131 of transaction optimizer device 130 may send to the one or more second data storage system (or an agent of the one or more second data storage system) the type optimal combination. The one or more second data storage system (or agent thereof) may accept, reject, or counter the type optimal combination, whereby the transaction optimizer device 130 may receive such acceptance, rejection or counter. If accepted, the transaction optimizer device 130 will instruct its one or more first data storage system 131 to instruct the transfer of the digital assets of first user first user 102 and/or second user second user 104 to the one or more second data storage system according to a schedule defined in the transaction optimization 142. If the initial transaction optimization 142 is countered by one or more of first user 102 and second user 104, transaction optimizer device 130 can either accept or reject the counteroffer, thus repeating the above steps. In this alternative embodiment, data storage system could be a custodial account storage (e.g. Coinbase PRIME) that custodies the various digital assets OR a self-custodial account (e.g. Metamask) that hosts the information needed for the transaction optimization.

In embodiments, acceptance, rejection, or counter of an initial transaction optimization 142 presented to first user 102 and/or second user 104 may be manually completed via user first user 102 interacting with a user interface 150 on associated first device 106, and/or second user 104 interacting with a user interface 152 on associated second device 108. User interface 150 and user interface 152 may be an input/output (e.g., touchscreen, mouse/keyboard, etc.) and associated human-readable data transmission (e.g., display, microphone, etc.) device.

The agent in the foregoing example could be a separate intelligent computing system, a digital asset custodian (e.g. Coinbase), a hardware wallet, a mobile device wallet, or other software system that is able to receive the type optimal combination and send data back to the intelligent computing system. Further, the agent could be a separate module within transaction optimizer device 130. For example, if the transfer involves the same custodian on both sides (e.g. sending from one Coinbase account to another Coinbase account), the custodian could use the same transaction optimizer device 130.

Within system 100, in some embodiments, transaction optimizer device 130 is located on a device that also includes the one or more first data storage system 131 that stores first-user asset-set definition 132 second-user asset-set definition 134 and stores and executes transaction optimizer module 136. Further, the intelligent computing system may be distributed across the one or more first data storage system 131. For example, each first data storage system may contain logic that, when acting in concert, comprises the intelligent computing system. This device can include a mobile device, laptop, hardware wallet, hard-drive, desktop, or cloud server. For example, in a mobile device the one or more first data storage system can reside in memory on the mobile device whereby the intelligent computing system is located on a processor. In other embodiments, transaction optimizer device 130 and the one or more first data storage system 131 are separate. For example, the one or more first data storage system may reside on a mobile device where the intelligent computing system resides on a cloud server that is in data communication with the mobile device. This latter example may be relevant when the digital currencies or tokens are with a third-party custodian, and a payer just holds a representation of the digital currencies or tokens on their mobile device application.

In certain embodiments, transaction optimizer device 130 may utilize an orchestration layer coupled to the one or more first data storage system 131 to coordinate the transfer of one or more digital assets when transaction optimization 142 is accepted by each party to the transaction. The orchestration layer acts as a digital protocol bridge when the digital currencies or tokens operate on different blockchain networks or blockchain protocols. For example, a user may have a Metamask wallet for holding ETH, a Coinbase PRIME account for holding BTC, and a Trust Wallet for holding SOL. The orchestration layer would receive instructions from the transaction optimizer device 130 (e.g., from transaction optimizer module 136) related to the type optimal combination of digital currencies or tokens for the transaction. The orchestration layer would then instruct each of the first data storage systems to transfer the specific digital asset held in each first data storage system to one or more second data storage systems according to the digital currency type or blockchain network protocol. The orchestration layer can be included in the transaction optimizer device 130 as, for example, a software layer or can be a separate software component (which may or may not be a component of transaction optimizer module 136). If separate, the transaction optimizer device 130 and orchestration layer may communicate via API. In a non-limiting embodiment, the one or more second data storage system may be coupled to a separate orchestration layer for receiving the transaction from the one or more first data storage system. An example orchestration layer is found in U.S. Pat. No. 11,651,353 herein incorporated by reference in its entirety.

In some embodiments, specific transactions and transfers according to transaction optimization 142 occur using a decentralized digital ledger system. A decentralized ledger system can include the Bitcoin network, Ethereum network, Polygon, Solana, and Avalanche. In other embodiments, the transaction occurs using a centralized system where the computing nodes effectuating the transaction reside in a central location (e.g. cloud, on-prem).

In some embodiments, transaction optimizer module 136 uses geolocation as a factor, data received from the first data storage system, or data related to the second data storage system to determine where a payer and payee are located. For example, one or more first data storage system 131 may store first-user location 160 and second-user location 162. First-user location 160 may be transmitted periodically, or on request during initiation of transaction optimization 142, from associated first device 106 to transaction optimizer device 130 to identify current location of first user 102. Second-user location 162 may be transmitted periodically, or on request during initiation of transaction optimization 142, from associated first device 106 to transaction optimizer device 130 to identify current location of second user 104. Geolocation is helpful when the payer and payee are located in different jurisdictions when the transaction 101 takes place, or the payer is not present in their home jurisdiction during the transaction 101. For example, certain digital assets (e.g. BAYC NFT) may have a higher value in one jurisdiction compared to the other. Thus, transaction optimizer device 130 can play arbitrage between the digital assets custodied in the first data storage system 131 and what the payee is willing to accept.

It should be appreciated that a variety of other factors may be used with regards to generate transaction optimization 142, such as geolocation of the parties to the transactions, party credit rating, or party selection criteria (e.g., one or more first-user parameters 116 or one or more second-user parameters 126).

The above description of system 100 enables a computer-implemented a system and method for optimizing digital asset transactions. The system and method may include custodying digital currencies or tokens in one or more first data storage system. Custodying can be either self-custody (e.g. Metamask wallet) or via a custodian (e.g. Coinbase PRIME) or a combination. For example, a user may have a Metamask wallet for holding ETH, a Coinbase PRIME account for holding BTC, and a Trust Wallet for holding SOL. The system and method may optimize the transactions from one or a combination of these first data storage systems. Further, the one or more first data storage system can be on a mobile device, laptop, desktop, hardware wallet, USB drive, hard-drive, or cloud server. Also, the one or more first data storage system may custody a representation of the digital currencies or tokens, whereby the actual digital currencies or tokens reside in one or more separate storage location (e.g. cold storage). For example, a mobile device may use Coinbase PRIME to hold a representation of the digital currency, whereby the actual digital currency resides on the Coinbase server hosted by Coinbase. In another example, the digital currency may be physically stored on a Bitkey hardware wallet but a representation held on the Bitkey mobile app. The above discussed system and method embody actual custody, self-custody, representative custody, or a combination, and in no way should be limited to just one type of custody.

The various functionality discussed herein may, in some embodiments, be implemented using a non-transitory computer-readable medium stores instructions that, when executed by a computer, cause the computer to perform the functions for optimizing digital asset transactions discussed herein. The method includes receiving data from a first data storage system, determining an optimal combination of digital currencies or tokens for the transaction based on a set of factors, and sending to the first data storage system the type optimal combination of digital currencies or tokens for the transaction.

In a non-limiting example, first user 102 selects four types of digital assets to be transferred to second user 104. Information 132 regarding the four types of digital assets is transmitted to transaction optimizer device 130, which includes origin history associated with a NFT. Second user 104 transmits its information 134 to the transaction optimizer requesting certain digital assets, however, the information 134 doesn't contain any compliance information regarding the types of digital assets 104 can accept. Transaction optimizer 130 knows the location of second user 104 and recognizes that second user 104 cannot receive at least one of the contemplated digital assets because second user's 104 country of residence doesn't permit that type of digital asset, thus rejecting the transaction. Further, transaction optimizer 130 suggests a different combination of digital assets to both first user 102 and second user 104, where the different combination of digital assets would be in compliance and satisfy the user criteria 132 and 134. First user 102 completes the optimized transaction by transferring the digital assets from first-user's Coinbase wallet 106 to second-user's Trust Wallet 108.

In a further non-limiting example, first user 102 selects four types of digital assets to be transferred to second user 104. Information 132 regarding the four types of digital assets is transmitted to transaction optimizer 130, which includes information regarding maximizing net-capital gain with the transaction. Second user 104 transmits its information 134 to the transaction optimizer 130, which includes a desirability indicator for a specific digital asset. Transaction optimizer 130 recognizes that the desired digital asset is not part of the contemplated transaction but that first user 102 has such digital asset on its first device 106. Transaction optimizer alerts first user 102 that second user 104 desires a particular digital asset, which could still maximize the net-gain to the first user 102. First user 102 can either “accept” the proposal from the transaction optimizer or “reject” (and, optionally, provide a reason) and select another digital asset for the transaction. Here, first user 102 accepts the proposal and transfers the digital assets from first user's Coinbase PRIME account 106 to second-user's Coinbase wallet 108.

In yet another non-limiting example, first user 102 selects four types of digital assets to be transferred to second user 104. The transaction optimizer 130 recognizes that one of the digital assets was previously associated with a company on the United States' sanction list (via information received from third-party evaluator 140 or other third party data source, for example) and rejects the desired transaction. Further, transaction optimizer 130 suggests an alternative, optimal combination of digital assets for the transaction that is both in compliance and satisfies any user defined criteria 132 and/or 134. Transaction optimizer also alerts user 102 that one of its digital assets may be out of compliance. First user 102 accepts the alternative combination and transfers the digital assets from its Coinbase PRIME account 106 to second-user's Coinbase PRIME account 108.

In yet a further non-limiting example, first user 102 selects four types of digital assets to be transferred to a second user 104 and includes information 132 regarding optimizing tax withholdings with the transfer. Second user 104 doesn't submit any criteria 134 regarding the transfer. Transaction optimizer 130, having access to second device 108, recognizes that second user would receive a tax benefit if it received a majority of one type of digital asset contemplated as part of the transfer and alerts second user 104 of the tax advantage. Second user 104 submits a counter-proposal to transaction optimizer 130, which then suggests a type-optimal combination of digital assets that maximizes the tax advantage for both first user 102 and second user 104. First user 102 accepts the type-optimal combination and transfers the digital assets from its self-custody wallet 106 to second user's Coinbase PRIME account 108.

In another non-limiting example, first user 102 selects four types of digital assets from four different storage devices 106A, 106B, 106C, and 106D to be transferred to second user 104. First user includes information 132 for each of the four types of digital assets, which information desires to maximize capital gains on digital assets 1-3 and liquidate all of first user's 102 holdings of digital asset 4. Second user 104 submits information 134 regarding maximizing taxes with the receipt of the digital assets and that each digital asset should be placed in specific wallets 108A, 108B, 108C, and 108D. Given the complexity of the wallet-to-wallet transfers, transaction optimizer utilizes an orchestration layer to more efficiently move the assets from first user's 102 wallets to second user's 104 wallets. Transaction optimizer suggests the type-optimal transaction given the user criteria 132 and 134, utilizes the orchestration layer to effectuate the transfers as follows: Digital Asset #1 from 106A to 108D; Digital Asset #2 from 106B to 108C; Digital Asset #3 from 106C to 108B; and Digital Asset #4 from 106D to 108A.

In each of the non-limiting examples, the transaction optimizer 130, learns the transaction behavior of the first user 102 and second user 104 through the user defined criteria. Transaction optimizer 130 can apply these learnings on the current transaction or future transaction involving either first user 102 or second user 104. Further, transaction optimizer takes these learnings from the users and combines them with one or more set of factors: type and value of the digital assets in the data storage system, the value of goods or services to be purchased, user past purchasing history, geo-location of a user, compliance history of a particular digital asset, tax implications associated with a digital asset, and real-time digital currency or token exchange data. This iterative process allows transaction optimizer 130 to be more efficient over time.

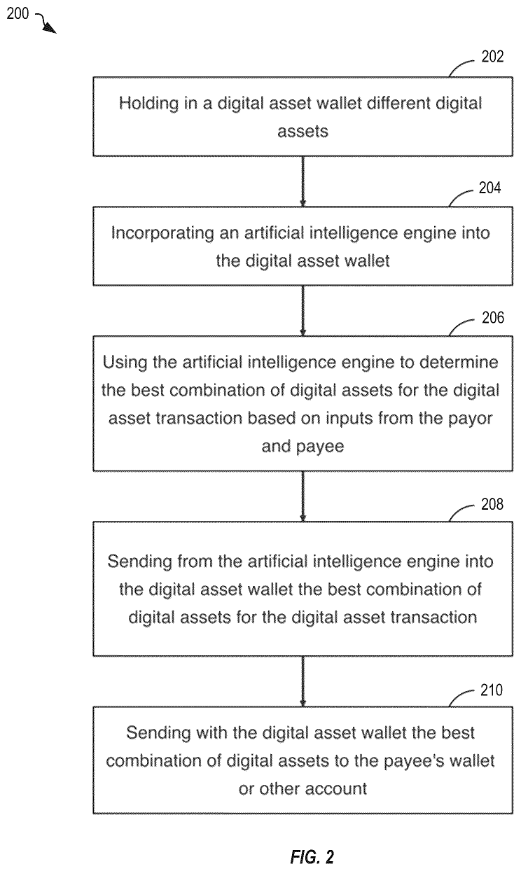

FIG. 2 is a flow diagram of an example method 200 of optimizing digital asset transactions using an artificial intelligence engine in a digital asset wallet in accordance with certain embodiments described herein. Method 200 may be implemented using system 100 described above.

The method 200 comprises holding in a digital asset wallet different digital assets in an operational block 202. In one example of operation, each of associated first device 106 and associated second device 108 hold one or more digital assets 110, 112, 114, or 120, 122, 124, respectively. Additionally, or alternatively, an example of operational block 202 may include transmitting the digital assets or a description/data regarding said digital assets to transaction optimizer device 130 as first-user asset-set definition 132 or second-user asset-set definition 134.

The method 200 further comprises incorporating an artificial intelligence engine into the digital asset wallet in an operational block 204. In on example of operation of block 204, transaction optimizer module 136 is incorporated into one or more first data storage system 131. Additionally, or alternatively, transaction optimizer module 136 may reside on one or both of associated first device 106 and associated second device 108 to allow respective user device to respond to a transaction request from the other user device with an optimal blend of digital assets owned by the user.

The method 200 further comprises using the artificial intelligence engine to determine the best combination of digital assets for the digital asset transaction based on inputs from the payor and payee in operational blocks 206. In one example of operation of block 206, transaction optimizer module 136 generates transaction optimization 142 based on an analysis of the digital assets as defined by the digital assets themselves, or a data representation thereof such as first-user asset-set definition 132 or second-user asset-set definition 134. Moreover, additional factors may be utilized to generate the best combination, such as geolocation of the parties (e.g., first-user location 160 and/or second-user location 162) to the transactions, party credit rating, or party selection criteria (e.g., one or more first-user parameters 116 or one or more second-user parameters 126).

The method 200 further comprises sending from the artificial intelligence engine into the digital asset wallet the best combination of digital assets for the digital asset transaction in an operational block 208. In one example of operation, transaction optimization 142 is transmitted from transaction optimizer device 130 to one or both of associated first device 106 and associated second device 108. Each user first user 102 and second user 104 may then accept, counter, or reject the parameters of the transaction defined in transaction optimization 142.

The method 200 further comprises sending with the digital asset wallet the best combination of digital assets to the payee's wallet or other account in an operational block 210. In one example of operation of block 210, transaction optimizer device 130 custodies and implements the transaction parameters in an accepted transaction between first user 102 and second user 104. In another example of operation of operational block 210, each associated first device 106 and associated second device 108 are used to implement the parameters within transaction optimization 142, and confirmation of the completed transactions are sent to transaction optimizer device 130 for close of escrow enabled by transaction optimizer device 130.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A computer-implemented method for optimizing digital asset transactions, comprising:
custodying in one or more first data storage system digital assets;
determining with a transaction optimizer module of an intelligent computing system an optimal combination of digital assets for a transaction based on a set of factors;
receiving from the intelligent computing system into the one or more first data storage system the optimal combination digital assets for the transaction; and
sending with the one or more first data storage system the optimal combination of digital assets to one or more second data storage system.

2. The method of claim 1, wherein the intelligent computing system is located on a device that also includes the one or more first data storage system.

3. The method of claim 1, wherein the set of factors is selected from the group consisting of: the type and value of the digital assets in the data storage system, the value of goods or services to be purchased, user past purchasing history, geo-location of a user, compliance history of a particular digital asset, tax implications associated with a digital asset, and real-time digital currency or token exchange data.

4. The method of claim 1, wherein the one or more first data storage system custodies multiple digital currencies or tokens.

5. The method of claim 4, wherein the digital currencies or tokens include cryptocurrency, non-fungible tokens, and digital representations of physical or intangible assets.

6. The method of claim 1, wherein the transaction occurs using a decentralized digital ledger system.

7. The method of claim 1, wherein the intelligent computing system uses geolocation to determine where a payer and payee are located.

8. The method of claim 1, the determining the optimal combination including accounting for at least one user-defined selection criteria regarding the transaction, the at least one selection criteria is selected from the group consisting of: the type of cryptocurrency, gain to one or more parties from transfer of a digital asset, loss to one or more parties from transfer of a digital asset, and request of a certain digital asset from another party.

9. The method of claim 1, wherein the intelligent computing system receives an acceptance, rejection, or counter from the one or more second data storage system or agent thereof.

10. The method of claim 9, wherein the intelligent computing system receives an acceptance from the one or more second data storage system or agent thereof and instructs the one or more first data storage system to send the optimal combination of digital currencies or tokens to the one or more second data storage system.

11. A system for optimizing digital asset transactions, comprising:
one or more first data storage system for custodying digital assets;
an intelligent computing system that uses data from the one or more first data storage system, wherein the data includes description of the digital assets stored in the one or more first data storage system; and
an optimal combination of digital assets for the transaction based on a set of factors considered by the intelligent computing system, wherein the one or more first data storage system is configured to send to one or more second data storage system the optimal combination of digital currencies or tokens.

12. The system of claim 11, wherein the intelligent computing system is located on a device that also includes the one or more first data storage system.

13. The system of claim 11, wherein the set of factors includes the type and value of digital assets in the data storage system, the value of goods or services to be purchased, a payer's and payee's past purchasing history, geo-location of a user, compliance history of a particular digital asset, tax implications associated with a digital asset, and real-time digital currency or token exchange data.

14. The system of claim 11, wherein the digital assets include cryptocurrency, non-fungible tokens, and digital representations of physical or intangible assets.

15. The system of one of claim 11, wherein the transaction occurs using a decentralized digital ledger system.

16. The system of one of claim 11, wherein the intelligent computing system uses geolocation to determine where parties to the transaction are located.

17. The system of one of claim 11, wherein a user selects at least one user-defined selection criteria regarding the transaction, the at least one selection criteria is selected from the group consisting of: the type of cryptocurrency, gain to one or more parties from transfer of a digital asset, loss to one or more parties from transfer of a digital asset, and request of a certain digital asset from another party.

18. The system of one of claim 11, wherein the intelligent computing system processes an acceptance, rejection, or counter from the one or more second data storage system or agent thereof.

19. The system of claim 18, wherein the intelligent computing system processes an acceptance from the one or more second data storage system or agent thereof and instructs the one or more first data storage system to send the optimal combination of digital currencies or tokens to the one or more second data storage system.

20. The system of claim 19, wherein the intelligent computing system processes a counter combination of digital assets from the one or more second data storage system or agent thereof.

21. A non-transitory computer-readable medium storing instructions that, when executed by a computer, cause the computer to perform a method for optimizing digital asset transactions, the method comprising:
receiving data from one or more first data storage system, wherein the data includes the type of digital currencies or tokens stored in the one or more first data storage system;
determining an optimal combination of digital currencies or tokens for the transaction based on a set of factors; and
sending to the one or more first data storage system the type optimal combination of digital currencies or tokens for the transaction.
